(19) United States
(12) Patent Application Publication
(10) Pub. No.: US 2025/0026900 A1
(43) Pub. Date: Jan. 23, 2025

(54) HEAT-SHRINKABLE POLYESTER FILM

(71) Applicant: FAR EASTERN NEW CENTURY CORPORATION, Taipei City (TW)

(72) Inventors: Yi-Wei CHANG, New Taipei City (TW); Li-Ling CHANG, Taipei City (TW); Yow-An LEU, Taipei City (TW)

(21) Appl. No.: 18/778,345

(22) Filed: Jul. 19, 2024

(30) Foreign Application Priority Data
Jul. 21, 2023 (TW) 112127385

(51) Int. Cl. C08J 5/18; B29C 71/02

(52) U.S. Cl. CPC C08J 5/18; C08J 7/08; C08J 2367/03

(57) ABSTRACT

A heat-shrinkable polyester film includes a polyester resin made from a dicarboxylic component including at least one of terephthalic acid and dimethyl terephthalate, and a diol component including ethylene glycol, 2-methyl-1,3-propanediol, and a diol selected from neopentyl glycol, 1,4-cyclohexanedimethanol, and a combination thereof. Based on 100 mol % of the diol component, the ethylene glycol, the diol mixture and the 2-methyl-1,3-propanediol are present in amounts ranging from 74 mol % to 82 mol %, from 18 mol % to 26 mol %, and from 3.5 mol % to 22 mol %, respectively. The heat-shrinkable polyester film has, after immersion in hot water at 95° C. for 10 seconds, a heat shrinkage in a direction transverse to a machine direction (TD) of greater than 48%, a heat shrinkage in the machine direction of less than 5%, an intrinsic viscosity of greater than 0.5 dL/g, and a yield strength in the TD ranging from 7.5 MPa to 13 MPa.

### CROSS-REFERENCE TO RELATED APPLICATION

This application claims priority to Taiwanese Invention Patent Application No. 112127385, filed on Jul. 21, 2023, and incorporated by reference herein in its entirety.

### FIELD

The present disclosure relates to a polyester film, and more particularly to a heat-shrinkable polyester film.

### BACKGROUND

WO 2022/072477 A1 discloses a heat-shrinkable film including a copolyester that is formed by subjecting raw material components to a polymerization reaction. The raw material components include a diacid component and a diol component. The diacid component includes at least one of terephthalic acid and dimethyl terephthalate. The diol component includes ethylene glycol, 2-methyl-1,3-propanediol, diethylene glycol, and at least one other glycol selected from neopentyl glycol and 1,4-cyclohexanedimethanol. By including the copolyester, the heat-shrinkable film has a low shrink onset temperature, and thus, when used as a sleeve label on an outer surface of a container, such application can be conducted under low energy consumption.

In general, a process for forming a sleeve label from a heat-shrinkable film involves subjecting the heat-shrinkable film to seaming and bonding process using a seaming machine, in which two end portions of the heat-shrinkable film are stacked on each other in a direction transverse to a machine direction, and a seaming agent is simultaneously applied between the two end portions to bond the two end portions together, so as to form a flat-elongated hollow film. Then, the flat-elongated hollow film is cut into several hollow cut pieces each having an appropriate size. Thereafter, the hollow part of each of the hollow cut pieces is spread open to form a sleeve, and then the sleeve is positioned around a container, followed by heat-shrinking the sleeve so that the sleeve shrinks to achieve tight labelling around the container. In case that the sleeve is not required to be made immediately, the flat-elongated hollow film usually will be rolled into a cylindrical film roll to be stored for later use. The cylindrical film roll can be unfolded into the flat-elongated hollow film during making of the sleeve.

In the aforesaid patent document, during the process of forming the sleeve label from the heat-shrinkable film, the seaming agent might seep into the inner surface or the outer surface of the flat-elongated hollow film from the two end portions of the heat-shrinkable film, causing the inner surface or outer surface of the flat-elongated hollow film to adhere thereto when the flat-elongated hollow film is rolled into a cylindrical film roll, resulting in difficulty in unfolding the cylindrical film roll into the flat-elongated hollow film or difficulty in spreading open the hollow part of each of the hollow cut pieces, thereby having a problem of difficulty in producing the sleeve. In addition, although the aforesaid patent document discloses that the rate of elongation of the heat-shrinkable film before and after being stored for a period of time is greater than 200%, experimental results have shown that the difference in elongation at break of the heat-shrinkable film before and after being stored for a period of is large (see Comparative Example 5 of the present disclosure which will be described hereinafter). Therefore, for a heat-shrinkable film that has been stored for a period of time, in the process of forming a flat-elongated hollow film or in the process of heat-shrinking the sleeve to wrap the container, such heat-shrinkable film or sleeve easily breaks due to external tensile force under a high production speed of 300 m/min to 500 m/min, causing suspension of production, thereby having a problem of decreased rate of production capacity. Moreover, experimental results have shown that the heat-shrinkable film will naturally shrink to a great extent after being stored for a period of time, causing the heat-shrinkable film to have a problem of uneven size after storage, and thus unable to meet the market demand.

In addition to the aforesaid patent document, U.S. Pat. No. 7,008,698 B2 and US 2008/0057237 A1 disclose that a shrinkable film formed using 2-methyl-1,3-propanediol has excellent shrinkage property. However, experimental results have shown that the shrinkable film formed using 2-methyl-1,3-propanediol has great changes in mechanical strength (e.g., elongation rate) after storage (compared with mechanical strength before storage), and addition of 2-methyl-1,3-propanediol in excessive amount will cause the shrinkable film to naturally shrink to a great extent, causing the shrinkable film to have a problem of uneven size after storage. Because of these problems, the shrinkable films disclosed in these patent documents have properties which are not acceptable in the current market.

TW 500654 B discloses that use of 10 mol % to 80 mol % of 1,4-cyclohexanedimethanol in combination with 0.1 mol % to 50 mol % of 2-methyl-1,3-propanediol is capable of reducing shrinkage stress of a heat-shrinkable film, so as to avoid, in the process of heat-shrinking of the heat-shrinkable film for wrapping a container, deformation of the container or whitening of the heat-shrinkable film, and to solve a problem of poor shrinkage at low temperature. However, this patent document does not mention that addition of glycol in excessive amount would cause the heat-shrinkable film to have a problem of uneven size after being stored for a period of time.

KR 2004-0051808 A discloses that a shrinkable film formed using 3 mol % to 45 mol % of 2-methyl-1,3-propanediol has a certain degree of shrinkage. This patent document further discloses that if the amount of 2-methyl-1,3-propanediol is less than 3 mol %, when a bottle is wrapped with the shrinkable film, a problem of the shoulder part of the bottle being loosened would occur due to shrinkage and sterilization treatment, and that if the amount of the 2-methyl-1,3-propanediol is greater than 45 mol %, problems such as folding of the ends, formation of shrinkage spots, generation of wrinkles and post-shrinkage deformation might occur due to the heat shrinkage speed being too fast. However, this patent document does not mention ways to improve the large changes in mechanical strength (e.g., elongation rate) and uneven size of the shrinkable film after storage for a period of time.

WO 2022/076763 A1 discloses a shrinkable polyester film comprising a polyester which is formed by reacting a diacid component and a diol component that includes ethylene glycol, 2-methyl-1,3-propanediol, 1,4-cyclohexanedimethanol, and diethylene glycol. The shrinkable polyester film has a shrinkage in a direction transverse to a machine direction of greater than 60% at 95° C., and a shrinkage rate of less than 4%/° C. between 65° C. and 80° C. The shrinkable polyester film is used as a sleeve label on an outer surface of a container. This patent document focuses on the control of shrinkage and shrinkage rate of the shrinkable polyester film to improve adhesion thereof to a container, so that containers made for different needs would retain a good appearance after adhesion. However, such patent document does not mention ways to improve the large changes in mechanical strength (e.g., elongation rate) of the shrinkable polyester film after storage (compared with mechanical strength before storage) and the uneven size of the shrinkable polyester film caused by inventory aging, and also does not consider the impact of aging of the shrinkable polyester film on the use of the same as a sleeve label. At the same time, since the composition of the polyester greatly affects the requirements of basic seaming and bonding process of the shrinkable polyester film including the polyester, the shrinkable polyester film disclosed in this patent document is unable to meet the requirements in the market.

### SUMMARY

Therefore, an object of the present disclosure is to provide a heat-shrinkable polyester film that can alleviate at least one of the drawbacks of the prior art.

According to the present disclosure, the heat-shrinkable polyester film includes a polyester resin made from a dicarboxylic component and a diol component. The dicarboxylic component includes at least one of terephthalic acid and dimethyl terephthalate. The diol component includes ethylene glycol and a diol mixture that includes a first diol and a second diol. The first diol is 2-methyl-1,3-propanediol. The second diol is selected from the group consisting of neopentyl glycol, 1,4-cyclohexanedimethanol, and a combination thereof. Based on 100 mol % of the diol component, the ethylene glycol is present in an amount ranging from 74 mol % to 82 mol %, the diol mixture is present in an amount ranging from 18 mol % to 26 mol %, and the 2-methyl-1,3-propanediol is present in an amount ranging from 3.5 mol % to 22 mol %. The heat-shrinkable polyester film has a heat shrinkage in a direction transverse to a machine direction of greater than 48% in hot water at 95° C. for 10 seconds, a heat shrinkage in the machine direction of less than 5% in hot water at 95° C. for 10 seconds, an intrinsic viscosity of greater than 0.5 dL/g, and a yield strength in the direction transverse to the machine direction which ranges from 7.5 MPa to 13 MPa.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a heat-shrinkable polyester film which includes a polyester resin made from a dicarboxylic component and a diol component. The dicarboxylic component includes at least one of terephthalic acid and dimethyl terephthalate. The diol component includes ethylene glycol and a diol mixture that includes a first diol and a second diol. The first diol is 2-methyl-1,3-propanediol, and the second diol is selected from the group consisting of neopentyl glycol, 1,4-cyclohexanedimethanol, and a combination thereof. Based on 100 mol % of the diol component, the ethylene glycol is present in an amount ranging from 74 mol % to 82 mol %, the diol mixture is present in an amount ranging from 18 mol % to 26 mol %, and the 2-methyl-1,3-propanediol is present in an amount ranging from 3.5 mol % to 22 mol %. The heat-shrinkable polyester has a heat shrinkage in a direction transverse to a machine direction of greater than 48% in hot water at 95° C. for 10 seconds, a heat shrinkage in the machine direction of less than 5% in hot water at 95° C. for 10 seconds, and an intrinsic viscosity of greater than 0.5 dL/g.

### [Heat-Shrinkable Polyester Film]

In certain embodiments, the terephthalic acid may be a recycled terephthalic acid. In certain embodiments, the dimethyl terephthalate may be a recycled dimethyl terephthalate.

In certain embodiments, the 2-methyl-1,3-propanediol is present in an amount ranging from 3.5 mol % to 20 mol % based on 100 mol % of the diol component. In certain embodiments, the second diol is present in an amount ranging from 4 mol % to 22 mol % based on 100 mol % of the diol component. In certain embodiments, the second diol is present in an amount ranging from 4 mol % to 17 mol % based on 100 mol % of the diol component. In certain embodiments, based on 100 mol % of the diol component, the diol mixture is present in an amount ranging from 21 mol % to 25 mol % and the 2-methyl-1,3-propanediol is present in an amount ranging from 17 mol % to 20 mol %. In certain embodiments, the diol component further includes bis(2-hydroxyethyl) terephthalate. In certain embodiments, the bis(2-hydroxyethyl) terephthalate may be a recycled bis(2-hydroxyethyl) terephthalate.

It should be noted that, when the diol mixture is present in an amount of less than 18 mol % based on 100 mol % of the diol component, the heat-shrinkable polyester film has insufficient shrinkage or a problem of difficulty in seaming may occur, and in the process of forming a flat-elongated hollow film from the heat-shrinkable polyester film and even after heat-shrinking the flat-elongated hollow film to wrap the container, two ends of the heat-shrinkable polyester film that are bonded together may be easily separated from each other due to external forces during subsequent processes. When the diol mixture is present in an amount of greater than 26 mol % based on 100 mol % of the diol component, apart from the significant increase in production cost, the problem of seeping may easily occur through the seam during the process of forming the heat-shrinkable polyester film, in which a seaming agent easily seeps into an inner surface or an outer surface of the flat-elongated hollow film, causing the inner surface or the outer surface of the flat-elongated hollow film to easily adhere thereto, thereby being not conducive to subsequent production of sleeves from the flat-elongated hollow film. At the same time, the heat-shrinkable polyester film may naturally shrink to a relatively large extent after being stored for a period of time, causing the heat-shrinkable polyester film to have a smaller size, and thus the heat-shrinkable polyester film has a problem of uneven size after storage. In addition, in certain cases, the heat-shrinkable polyester film may have insufficient mechanical strength, resulting in breakage because of failure to withstand external force, that is, the heat-shrinkable polyester film, in the process of forming the flat-elongated hollow film or in the subsequent process of heat-shrinking the sleeve to wrap a container, easily breaks due to external force under a high production speed, thereby affecting production capacity. Therefore, the content of the diol mixture greatly affects the properties and applications of the heat-shrinkable polyester film.

In certain embodiments, the heat shrinkage of the heat-shrinkable polyester film in the direction transverse to the machine direction is not less than 55% in hot water at 95° C. for 10 seconds. In certain embodiments, the heat shrinkage of the heat-shrinkable polyester film in the direction transverse to a machine direction is not less than 65% in hot water at 95° C. for 10 seconds. In certain embodiments, the heat shrinkage of the heat-shrinkable polyester film in the machine direction is not greater than 4% in hot water at 95° C. for 10 seconds.

In certain embodiments, the heat-shrinkable polyester film has a natural shrinkage that is not greater than 1% and that is calculated using the following Equation (I):

$$Natural shrinkage = [ ( {A}_{0} - {A}_{1} ) \div {A}_{0} ] \times 100 \% . \qquad ( I )$$

wherein,
A₀ represents a first length of the heat-shrinkable polyester film in a direction before a treatment, and
A₁ represents a second length of the heat-shrinkable polyester film in the direction after the treatment, the heat-shrinkable polyester film in the treatment being treated at a temperature of 40° C. and a relative humidity of 65% for 168 hours. When the natural shrinkage is greater than 1%, the heat-shrinkable polyester film will naturally shrink to a relatively large extent after being stored for a period of time, causing the heat-shrinkable polyester film to have a smaller size, and thus the heat-shrinkable polyester film has a problem of uneven size after storage.

In certain embodiments, the heat-shrinkable polyester film has a variation of elongation at break that is not greater than 100% and that is an absolute value of difference in elongation at break of the heat-shrinkable polyester film before an aging treatment and elongation at break of the heat-shrinkable polyester film after the aging treatment. In the aging treatment, the heat-shrinkable polyester film is treated at a temperature of 60° C. for 1 hour. When the variation of elongation at break is greater than 100%, the heat-shrinkable polyester film has insufficient mechanical strength, resulting in breakage because of failure to withstand external force, that is, the heat-shrinkable polyester film, in the process of forming the flat-elongated hollow film or in the process of heat-shrinking the sleeve to wrap the container, easily breaks due to external force under a high production speed.

In certain embodiments, the heat-shrinkable polyester film has a yield strength in the direction transverse to the machine direction which ranges from 7.5 MPa to 13 MPa. When the yield strength in the direction transverse to the machine direction is greater than 13 MPa, the problem of insufficient strength of the heat-shrinkable polyester film easily occurs during seaming, that is, in the process of forming the flat-elongated hollow film, two end portions of the heat-shrinkable polyester film are easily affected by external forces during subsequent processes and become separated from each other, causing the average peel strength to be too low, and resulting in poor bonding stability. On the other hand, when the yield strength in the direction transverse to the machine direction is less than 7.5 MPa, the problem of seeping easily occurs through the seam during the process of forming the heat-shrinkable polyester film, in which the seaming agent easily seeps into the inner surface or the outer surface of the flat-elongated hollow film, causing the inner surface or the outer surface of the flat-elongated hollow film easily adhere thereto, thereby being not conducive to subsequent production of sleeves.

In certain embodiments, the heat-shrinkable polyester film has a thickness ranging from 35 μm to 50 μm. In certain embodiments, the heat shrinkage of the heat-shrinkable polyester film in the direction transverse to the machine direction is not less than 72% after immersing the heat-shrinkable polyester film in hot water at 95° C. for 10 seconds. In certain embodiments, the heat shrinkage of the heat-shrinkable polyester film in the machine direction is not greater than 3% after immersing the heat-shrinkable polyester film in hot water at 95° C. for 10 seconds.

In certain embodiments, the diol component is free from polyethylene glycol [—O(CH₂CH₂O)ₙ—, n being not less than 2]. In certain embodiments, the polyethylene glycol is diethylene glycol or triethylene glycol. It should be noted that, in a reaction (including a condensation reaction and a polymerization reaction) of the dicarboxylic component and the diol component, polyethylene glycol will be produced naturally due to the presence of ethylene glycol, and thus even if the diol component of the present disclosure is free from polyethylene glycol, the structure of the polyester of the present disclosure will still include segments of polyethylene glycol.

Examples of the condensation reaction include esterification reaction and transesterification reaction. In certain embodiments, the condensation reaction is conducted at a temperature ranging from 220° C. to 270° C. for a time period ranging from 120 minutes to 480 minutes. In certain embodiments, the polymerization reaction is conducted at a temperature ranging from 250° C. to 290° C. for a time period ranging from 120 minutes to 480 minutes.

### [Method for Preparing Heat-Shrinkable Polyester Film]

The present disclosure also provides a method for preparing the heat-shrinkable polyester film of the present disclosure which includes the steps of: (a) forming a polyester sheet that is not yet stretched (hereinafter referred to as unstretched polyester sheet) from a polyester component including a polyester material; and (b) subjecting the unstretched polyester sheet to a preheating treatment, a stretching treatment, and an annealing treatment in sequence.

The polyester material in step (a) of the method is the same polyester material as described in the foregoing, and details thereof are not repeated herein for the sake of brevity.

The unstretched polyester sheet may have a thickness similar to that of a conventional sheet for forming a heat-shrinkable polyester film, or a thickness that is adjusted according to the requirement for an object to be applied with the heat-shrinkable polyester film. In certain embodiments, the polyester material is subjected to a melting treatment and an extruding treatment, so as to obtain the unstretched polyester sheet. In certain embodiments, a twin-screw extruder is used to form the unstretched polyester sheet. In certain embodiments, the unstretched polyester sheet has a thickness ranging from 140 μm to 240 μm. In certain embodiments, the unstretched polyester sheet has a glass transition temperature ranging from 68° C. to 77° C.

The preheating treatment is intended to soften the unstretched polyester sheet, so that the stretching treatment can be facilitated subsequently. The temperature of the preheating treatment may be adjusted according to the material of the unstretched polyester sheet and the conditions of the stretching treatment. In certain embodiments, the preheating treatment is performed at a glass transition temperature of the unstretched polyester sheet −20° C. to the glass transition temperature of the unstretched polyester sheet +60° C. The stretching treatment may be conducted by stretching the polyester sheet in the machine direction or the direction transverse to the machine direction. In certain embodiments, the stretching treatment may be conducted by stretching along at least one of the machine direction and the direction transverse to the machine direction at a stretching temperature that is performed at a glass transition temperature of the unstretched polyester sheet −40° C. to the glass transition temperature of the unstretched polyester sheet +60° C. In certain embodiments, the stretching treatment may be conducted at a stretch ratio ranging from 4 to 6. In certain embodiments, the annealing treatment is performed at a glass transition temperature of the unstretched polyester sheet −40° C. to the glass transition temperature of the unstretched polyester sheet +60° C.

The present disclosure will be described by way of the following examples. However, it should be understood that the following examples are intended solely for the purpose of illustration and should not be construed as limiting the present disclosure in practice.

### Preparation of Heat-Shrinkable Polyester Film

### Example 1 (EX1)

First, terephthalic acid in an amount of 100% based on 100% of a dicarboxylic acid component was mixed with a diol component including ethylene glycol in amount of 81 mol % and a diol mixture in an amount of 19%, based on 100% of a diol component, and also with 300 ppm of tetraethylammonium hydroxide (based on a total weight of a polyester resin to be obtained), so as to form a reaction mixture, in which the diol mixture included 2-methyl-1,3-propanediol (serving as a first diol) in an amount of 15 mol % and neopentyl glycol (serving as a second diol) in an amount of 4%. Next, the reaction mixture was heated to 250° C. and then subjected to an esterification reaction under a nitrogen atmosphere. When the amount of distilled water reached the theoretical value of the esterification reaction, 340 ppm of antimony ethylene glycolate (serving as a catalyst) and 15 ppm of trimethyl phosphate (serving as a heat stabilizer) were added, followed by conducting a polymerization reaction at 275° C. under a vacuum atmosphere, so as to obtain the polyester resin which had an intrinsic viscosity of 0.52 dL/g.

Afterwards, the polyester resin was dried until a moisture content thereof was not greater than 500 ppm, so as to obtain a dried polyester resin. Thereafter, the dried polyester resin was introduced into a twin-screw extruder and subjected to a melting treatment, in which the temperature thereof was increased in multiple stages from 210° C. to 260° C. Then, an unstretched polyester sheet including a first polyester layer, a second polyester layer and a third polyester layer which were stacked from top to bottom thereof in a thickness ratio of 1:8:1, was extruded from a die assembly. After that, the unstretched polyester sheet was subjected to a casting treatment by passing through a cold drum which had a thickness of 190 μm and a glass transition temperature of 72° C.

Subsequently, the unstretched polyester sheet was cut to obtain a cut polyester sheet having a length in a direction transverse to a machine direction (TD) of 12 cm and another length in the machine direction (MD) of 30 cm. Thereafter, by using a stretching machine (Manufacturer: Bruckner; Model no.: Karo IV), the cut polyester sheet was subjected to a preheating treatment at 79° C., and then to a stretching treatment conducted at 71° C. and a stretching rate of 34%/second along the TD, followed by an annealing treatment at 56° C., so as to form a heat-shrinkable polyester film of EX1 having a thickness of 40 μm.

### Examples 2 to 8 (EX2 to EX8) and Comparative Examples 1 to 15 (CE1 to CE15)

The procedures and conditions for preparing the heat-shrinkable polyester films of Examples 2 to 8 (EX2 to EX8) and Comparative Examples 1 to 15 (CE1 to CE15) were substantially similar to those of EX1, except for the differences in the type and amount of the components thereof, as shown in Tables 1 to 5 below.

TABLE 1

| | | | EX1 | EX2 | EX3 | EX4 |
|---|---|---|---|---|---|---|
| Dicarboxylic | Terephthalic acid | | 100 | 100 | 100 | 100 |
| component | | | | | | |
| (mol %) | | | | | | |
| Diol | Ethylene glycol | | 81 | 79 | 76 | 75 |
| component | Diol | 2-methyl-1,3-propanediol | 15 | 17 | 20 | 17 |
| (mol %) | mixture | Neopentyl glycol | 4 | 4 | 4 | 8 |
| | | 1,4-cyclohexanedimethanol | 0 | 0 | 0 | 0 |
| | | Diethylene glycol | 0 | 0 | 0 | 0 |
| | | Triethylene glycol | 0 | 0 | 0 | 0 |
| | | Total weight | 19 | 21 | 24 | 25 |

| Tetraethylammonium hydroxide (ppm) | | 300 | 300 | 300 | 300 |
|---|---|---|---|---|---|
| Esterification | Temperature (° C.) | 250 | 250 | 250 | 250 |
| reaction | Time (minute) | 330 | 300 | 330 | 330 |
| Polymerization | Temperature (° C.) | 275 | 275 | 275 | 275 |
| reaction | Time (minute) | 190 | 180 | 275 | 200 |
| Catalyst | Antimony ethylene | 340 | 340 | 340 | 340 |
| | glycolate (ppm) | | | | |
| Heat stabilizer | Trimethyl phosphate (ppm) | 15 | 15 | 15 | 15 |
| Unstretched polyester | Glass transition | 72 | 71 | 70 | 69 |
| sheet | temperature (° C.) | | | | |
| | Thickness (μm) | 190 | 190 | 190 | 190 |
| Preheating treatment | Temperature (° C.) | 79 | 79 | 79 | 77 |
| Stretching treatment | Temperature (° C.) | 71 | 71 | 71 | 69 |
| Annealing treatment | Temperature (° C.) | 56 | 56 | 56 | 54 |
| | Time (second) | 8 | 8 | 8 | 8 |
| Heat-shrinkable | Thickness (μm) | 40 | 40 | 40 | 40 |
| polyester film | | | | | |

TABLE 2

| | | | EX5 | EX6 | EX7 | EX8 |
|---|---|---|---|---|---|---|
| Dicarboxylic | Terephthalic acid | | 100 | 100 | 100 | 100 |
| component | | | | | | |
| (mol %) | | | | | | |
| Diol | Ethylene glycol | | 75 | 78 | 79.5 | 75 |
| component | Diol | 2-methyl-1,3-propanediol | 17 | 5 | 3.5 | 17 |
| (mol %) | mixture | Neopentyl glycol | 4 | 17 | 17 | 5 |
| | | 1,4-cyclohexanedimethanol | 4 | 0 | 0 | 0 |
| | | Diethylene glycol | 0 | 0 | 0 | 3 |
| | | Triethylene glycol | 0 | 0 | 0 | 0 |
| | | Total weight | 25 | 22 | 20.5 | 25 |

| Tetraethylammonium hydroxide (ppm) | | 300 | 300 | 300 | 300 |
|---|---|---|---|---|---|
| Esterification | Temperature (° C.) | 250 | 250 | 250 | 250 |
| reaction | Time (minute) | 330 | 330 | 300 | 300 |
| Polymerization | Temperature (° C.) | 275 | 275 | 275 | 275 |
| reaction | Time (minute) | 290 | 250 | 220 | 210 |
| Catalyst | Antimony ethylene | 340 | 340 | 340 | 340 |
| | glycolate (ppm) | | | | |
| Heat stabilizer | Trimethyl phosphate (ppm) | 15 | 15 | 15 | 15 |
| Unstretched polyester | Glass transition | 71 | 74 | 74 | 69 |
| sheet | temperature (° C.) | | | | |
| | Thickness (μm) | 190 | 190 | 190 | 190 |
| Preheating treatment | Temperature (° C.) | 82 | 85 | 85 | 77 |
| Stretching treatment | Temperature (° C.) | 74 | 77 | 77 | 69 |
| Annealing treatment | Temperature (° C.) | 59 | 62 | 62 | 54 |
| | Time (second) | 8 | 8 | 8 | 8 |
| Heat-shrinkable | Thickness (μm) | 40 | 40 | 40 | 40 |
| polyester film | | | | | |

TABLE 3

| | | | CE1 | CE2 | CE3 | CE4 | CE5 |
|---|---|---|---|---|---|---|---|
| Dicarboxylic | Terephthalic acid | | 100 | 100 | 100 | 100 | 100 |
| component | | | | | | | |
| (mol %) | | | | | | | |
| Diol | Ethylene glycol | | 80 | 71 | 75 | 72 | 62 |
| component | Diol | 2-methyl-1,3-propanediol | 20 | 25 | 17 | 17 | 18 |
| (mol %) | mixture | Neopentyl glycol | 0 | 4 | 0 | 0 | 10 |
| | | 1,4-cyclohexanedimethanol | 0 | 0 | 0 | 11 | 0 |
| | | Diethylene glycol | 0 | 0 | 8 | 0 | 10 |
| | | Triethylene glycol | 0 | 0 | 0 | 0 | 0 |
| | | Total weight | 20 | 29 | 25 | 28 | 38 |

| Tetraethylammonium hydroxide (ppm) | | 300 | 300 | 300 | 300 | 300 |
|---|---|---|---|---|---|---|
| Esterification | Temperature (° C.) | 250 | 250 | 250 | 250 | 250 |
| reaction | Time (minute) | 330 | 330 | 330 | 340 | 330 |
| Polymerization | Temperature (° C.) | 275 | 275 | 275 | 275 | 275 |
| reaction | Time (minute) | 180 | 270 | 215 | 220 | 290 |
| Catalyst | Antimony ethylene | 340 | 340 | 340 | 340 | 340 |
| | glycolate (ppm) | | | | | |
| Heat stabilizer | Trimethyl phosphate | 15 | 15 | 15 | 15 | 15 |
| | (ppm) | | | | | |
| Unstretched polyester | Glass transition | 71 | 68 | 66 | 71 | 65 |
| sheet | temperature (° C.) | | | | | |
| | Thickness (μm) | 190 | 190 | 190 | 190 | 190 |
| Preheating treatment | Temperature (° C.) | 79 | 79 | 74 | 82 | 75 |
| Stretching treatment | Temperature (° C.) | 71 | 71 | 66 | 74 | 67 |
| Annealing treatment | Temperature (° C.) | 56 | 56 | 51 | 59 | 52 |
| | Time (second) | 8 | 8 | 8 | 8 | 8 |
| Heat-shrinkable | Thickness (μm) | 40 | 40 | 40 | 40 | 40 |
| polyester film | | | | | | |

TABLE 4

| | | | CE6 | CE7 | CE8 | CE9 | CE10 |
|---|---|---|---|---|---|---|---|
| Dicarboxylic | Terephthalic acid | | 100 | 100 | 100 | 100 | 100 |
| component | | | | | | | |
| (mol %) | | | | | | | |
| Diol | Ethylene glycol | | 66.9 | 66.2 | 68 | 66 | 82.5 |
| component | Diol | 2-methyl-1,3-propanediol | 8.4 | 11.2 | 24 | 24 | 3.5 |
| (mol %) | mixture | Neopentyl glycol | 18.9 | 16.2 | 0 | 0 | 14 |
| | | 1,4-cyclohexanedimethanol | 0 | 0 | 0 | 0 | 0 |
| | | Diethylene glycol | 5.8 | 6.4 | 8 | 8 | 0 |
| | | Triethylene glycol | 0 | 0 | 0 | 2 | 0 |
| | | Total weight | 33.1 | 33.8 | 32 | 34 | 17.5 |

| Tetraethylammonium hydroxide (ppm) | | 300 | 300 | 300 | 300 | 300 |
|---|---|---|---|---|---|---|
| Esterification | Temperature (° C.) | 250 | 250 | 250 | 250 | 250 |
| reaction | Time (minute) | 330 | 330 | 330 | 340 | 330 |
| Polymerization | Temperature (° C.) | 275 | 275 | 275 | 275 | 275 |
| reaction | Time (minute) | 320 | 330 | 260 | 280 | 180 |
| Catalyst | Antimony ethylene | 340 | 340 | 340 | 340 | 340 |
| | glycolate (ppm) | | | | | |
| Heat stabilizer | Trimethyl phosphate | 15 | 15 | 15 | 15 | 15 |
| | (ppm) | | | | | |
| Unstretched polyester | Glass transition | 66 | 65 | 63 | 61 | 75 |
| sheet | temperature (° C.) | | | | | |
| | Thickness (μm) | 190 | 190 | 190 | 190 | 190 |
| Preheating treatment | Temperature (° C.) | 74 | 74 | 73 | 72 | 85 |
| Stretching treatment | Temperature (° C.) | 66 | 66 | 64 | 63 | 77 |
| Annealing treatment | Temperature (° C.) | 51 | 51 | 49 | 48 | 62 |
| | Time (second) | 8 | 8 | 8 | 8 | 8 |
| Heat-shrinkable | Thickness (μm) | 40 | 40 | 40 | 40 | 40 |
| polyester film | | | | | | |

TABLE 5

| | | | CE11 | CE12 | CE13 | CE14 | CE15 |
|---|---|---|---|---|---|---|---|
| Dicarboxylic | Terephthalic acid | | 100 | 100 | 100 | 100 | 100 |
| component | | | | | | | |
| (mol %) | | | | | | | |
| Diol | Ethylene glycol | | 73.5 | 73.5 | 75.5 | 82.5 | 73.5 |
| component | Diol | 2-methyl-1,3-propanediol | 3.5 | 22.5 | 22.5 | 17 | 20 |
| (mol %) | mixture | Neopentyl glycol | 23 | 4 | 2 | 0.5 | 6.5 |
| | | 1,4-cyclohexanedimethanol | 0 | 0 | 0 | 0 | 0 |
| | | Diethylene glycol | 0 | 0 | 0 | 0 | 0 |
| | | Triethylene glycol | 0 | 0 | 0 | 0 | 0 |
| | | Total weight | 26.5 | 26.5 | 24.5 | 17.5 | 26.5 |

| Tetraethylammonium hydroxide (ppm) | | 300 | 300 | 300 | 300 | 300 |
|---|---|---|---|---|---|---|
| Esterification | Temperature (° C.) | 250 | 250 | 250 | 250 | 250 |
| reaction | Time (minute) | 330 | 300 | 320 | 300 | 300 |
| Polymerization | Temperature (° C.) | 275 | 275 | 275 | 275 | 275 |
| reaction | Time (minute) | 210 | 210 | 250 | 180 | 220 |
| Catalyst | Antimony ethylene | 340 | 340 | 340 | 340 | 340 |
| | glycolate (ppm) | | | | | |
| Heat stabilizer | Trimethyl phosphate | 15 | 15 | 15 | 15 | 15 |
| | (ppm) | | | | | |
| Unstretched polyester | Glass transition | 74 | 69 | 70 | 72 | 69 |
| sheet | temperature (° C.) | | | | | |
| | Thickness (μm) | 190 | 190 | 190 | 190 | 190 |
| Preheating treatment | Temperature (° C.) | 85 | 77 | 79 | 80 | 77 |
| Stretching treatment | Temperature (° C.) | 77 | 69 | 71 | 73 | 69 |
| Annealing treatment | Temperature (° C.) | 62 | 54 | 56 | 57 | 54 |
| | Time (second) | 8 | 8 | 8 | 8 | 8 |
| Heat-shrinkable | Thickness (μm) | 40 | 40 | 40 | 40 | 40 |
| polyester film | | | | | | |

### Property Evaluation

The heat-shrinkable polyester films of EX1 to EX8 and CE1 to CE15 were subjected to measurements described below. The results for the measurements are listed in Tables 6 to 8 below.

1. Intrinsic Viscosity (Unit: dL/g)

Intrinsic viscosity of each of the heat-shrinkable polyester films was measured using standard test method for determining inherent viscosity of poly(ethylene terephthalate) by glass capillary viscometer according to the procedures set forth in ASTM D4603 (published in 2003). First, 0.25±0.0025 g of each of the heat-shrinkable polyester films was added to 25 ml of a solvent containing 60 wt % of phenol and 40 wt % of 1,1,2,2-tetrachloroethane, so as to form a solution mixture. Next, the solution mixture was heated at 110° C.±10° C. for 1 hour, and then subjected to cooling, so as to form a test sample. Thereafter, the test sample was subjected to measurement at 25° C. using an Ostwald viscometer, followed by calculation of intrinsic viscosity using the Huggins equation.

### 2. Glass Transition Temperature (Tg, Unit: ° C.)

Glass transition temperature of each of the heat-shrinkable polyester films was measured using a differential scanning calorimeter (DSC) (Manufacturer: TA Instruments, Inc.; Model: 2910 Modulated DSC™), in which the test temperature was raised from −50° C. to 300° C. at a heating rate of 10° C./minute, so as to obtain a heat capacity-temperature variation curve, followed by determination of Tg from the heat capacity-temperature variation curve.

### 3. Heat Shrinkage at 95° C. (Unit: %)

Heat shrinkage at 95° C. of each of the heat-shrinkable polyester films was measured according to the procedures set forth in JIS Z1709 (published as updated version in 2017). First, each of the heat-shrinkable polyester films was cut into a test sample having a dimension of 100 mm (in a machine direction [MD])×100 mm (in a direction transverse to the machine direction [TD]). That is, the test sample had an original length of 100 mm in both the MD and TD. Next, the test sample was subjected to immersion in hot water at 95° C. for 10 seconds, and was then removed from the hot water, followed by cooling in cold water at 30° C. for 30 seconds. Thereafter, the test sample was subjected to measurement of the length in the MD (LMD) and the length in the TD (LTD). The heat shrinkage of the test sample in the MD and in the TD were respectively calculated using the following Equations (II) and (III):

$$\begin{matrix}Heat shrinkage at 95 ° C . in TD ( \% ) = [ ( 100 - {L}_{TD} ) / 100 ] \times 100 \% & ( II ) \\ Heat shrinkage at 95 ° C . in MD ( \% ) = [ ( 100 - {L}_{MD} ) / 100 ] \times 100 \% & ( III )\end{matrix}$$

### 4. Yield Strength at a Direction Transverse to a Machine Direction (TD) (Unit: MPa)

Yield strength at TD of each of the heat-shrinkable polyester films was measured according to the procedures set forth in ASTM D882 (published in 2018). First, each of the heat-shrinkable polyester films was cut into a test sample having a length of 15 mm in MD and a length of 150 mm in TD. Next, the test sample was disposed in a tensile testing machine (Manufacturer: Cometech Testing Machines Co., Ltd.; Model No.: QC-508B1), and then two ends of the test sample were respectively fixed using two clamping tools at a distance of 100 mm apart in the TD, followed by stretching the test sample at the two ends thereof until the test sample breaks, so as to obtain a stress-strain curve. The yield point at which plastic deformation begins to occur can be determined from the stress-strain curve, and the stress corresponding to the yield point is the yield strength.

### 5. Elongation at Break (Unit: %) and Variation of Elongation at Break (Unit: %)

Elongation at break and variation of elongation at break of each of the heat-shrinkable polyester films were measured according to the procedures set forth in ASTM D882 (published in 2018). First, each of the heat-shrinkable polyester films was cut into two pieces of test samples, i.e., a first test sample and a second test sample, each having a length of 150 mm in MD and a length of 15 mm in TD. Next, the first test sample was disposed in a tensile testing machine (Manufacturer: Cometech Testing Machines Co., Ltd.; Model No.: QC-508B1), and then two ends of the first test sample were respectively fixed using two clamping tools at a distance of 100 mm apart in the MD. Thereafter, the first test sample was stretched at the two ends thereof until the first test sample breaks off, followed by measuring a distance between the two clamping tools when the first sample breaks (D₀). Afterwards, the second test sample was placed in an oven having a temperature of 60° C. for 1 hour to induce aging, thereby obtaining an aged second test sample. Then, the aged second test sample was subjected to the aforesaid procedures as conducted on the first test sample, followed by measuring a distance between the two clamping tools when the aged second test sample breaks (D₁). The elongation at break of the first test sample (E₀) and the elongation at break of the aged second test sample (E₁) were respectively calculated using the following Equations (IV) and (V):

$$\begin{matrix}{E}_{0} ( \% ) = [ ( {D}_{0} - 100 ) \div 100 ] \times 100 \% & ( IV ) \\ {E}_{1} ( \% ) = [ ( {D}_{1} - 100 ) \div 100 ] \times 100 \% & ( V )\end{matrix}$$

Variation of elongation at break was calculated using the following Equation (VI):

$$Variation of elongation at break = \vert {E}_{0} - {E}_{1} \vert \qquad ( VI )$$

### 6. Natural Shrinkage (Unit: %)

Natural shrinkage of each of the heat-shrinkable polyester films was measured using the procedures described as follows. First, each of the heat-shrinkable polyester films was cut into a test sample having a dimension of 100 mm (in MD)×100 mm (in TD). That is, the test sample had an original length of 100 mm in both the MD and TD. Next, the test sample was subjected to treatment by placing the same in a hot air oven having a constant temperature of 40° C. and a constant relative humidity of 65% for 168 hours, so as to obtain a treated test sample, followed by taking the treated test sample out from the hot air oven. Thereafter, the treated test sample was subjected to measurement of the length in the TD (LTD). The natural shrinkage of the treated test sample in the TD was calculated using the following Equation (VII):

$$Natural shrinkage in TD ( \% ) = [ ( 100 - {L}_{TD} ) / 100 ] \times 100 \% \qquad ( VII )$$

### 7. Peel Strength (Unit: Gf/Mm)

Peel strength of each of the heat-shrinkable polyester films was measured using the procedures described as follows. First, two end portions of each of the heat-shrinkable polyester films were stacked on each other in the TD using a seaming machine (Manufacturer: Webcontrol Machinery Corp.), and 1,3-dioxolane (serving as a seaming agent) was simultaneously applied between the two end portions to bond the two end portions together, so as to form a flat-elongated hollow polyester film. Next, the flat-elongated hollow polyester film was cut into a hollow cut film having a length in the MD of 15 cm. Afterwards, the two end portions of the hollow cut film which were stacked on each other were cut, so as to obtain 5 test samples, each with a strip-shaped and each including two sliced pieces which were stacked on each other. Each of the test samples had a length of 3 cm in the MD and a length of 20 cm in the TD. Thereafter, each of the test samples was disposed in a peel strength testing machine (Manufacturer: INSTRON; Model no.: 5566), and then a tensile stress with increasing strength along the TD was applied to one of the two sliced pieces of each test sample under a peeling speed of 100 mm/min, until the two sliced pieces were separated from each other. For each of the test samples, the tensile stress when the two sliced pieces separated was determined, and then the peel strength of each test sample was calculated from such tensile stress.

### 8. Degree of Seeping

Degree of seeping of each of the heat-shrinkable polyester films was measured using the procedures described as follows. First, the two end portions of each of the heat-shrinkable polyester films were stacked on each other in the TD using a seaming machine (Manufacturer: Webcontrol Machinery Corp.), and 1,3-dioxolane (serving as a seaming agent) was simultaneously applied between the two end portions to bond the two end portions together, so as to form a flat-elongated hollow polyester film, followed by rolling the flat-elongated hollow polyester film into a cylindrical polyester film roll. Next, the cylindrical polyester film roll was placed in an environment with a temperature of 28° C. for 30 days. Thereafter, a cut polyester film having a length in the MD of 100 cm was cut from the inner portion of the cylindrical polyester film roll, followed by determining the proportion of the seaming agent present on the surface of the cut polyester film relative to the entire surface of the cut polyester film. The degree of seeping for each of the test samples was indicated in Tables 6 to 8 below as follows: the symbols “O” and “X” respectively represent the proportion of the seaming agent present on the surface of the cut polyester film relative to the entire surface of the cut polyester film being not greater than 5% and those being greater than 5%.

TABLE 6

| Property evaluation | | | | | | | | | |
|---|---|---|---|---|---|---|---|---|---|
| of heat-shrinkable | | | | | | | | | |
| polyester film | | EX1 | EX2 | EX3 | EX4 | EX5 | EX6 | EX7 | EX8 |
| Intrinsic viscosity (dL/g) | | 0.62 | 0.65 | 0.60 | 0.62 | 0.62 | 0.62 | 0.63 | 0.63 |
| Glass transition | | 72 | 71 | 70 | 69 | 71 | 74 | 74 | 69 |
| temperature (° C.) | | | | | | | | | |
| Heat shrinkage in | | 72 | 74.5 | 75.6 | 75.7 | 75 | 75.8 | 75.3 | 75 |
| TD at 95° C. (%) | | | | | | | | | |
| Heat shrinkage in | | 2.9 | −1.1 | −0.1 | −0.4 | −2.1 | −1.0 | −1.2 | −0.5 |
| MD at 95° C. (%) | | | | | | | | | |
| Yield strength | | 12.4 | 10.3 | 8.2 | 7.6 | 8.4 | 8.1 | 10 | 8.3 |
| in TD (MPa) | | | | | | | | | |
| Elongation at | E₀ (%) | 464 | 455 | 407 | 443 | 424 | 491 | 483 | 472 |
| break | E₁ (%) | 449 | 449 | 400 | 424 | 400 | 400 | 452 | 433 |
| Variation of | E₀-E₁ | 15 | 6 | 7 | 19 | 24 | 91 | 31 | 39 |
| elongation at | (%) | | | | | | | | |
| break | | | | | | | | | |

| | | | | | | | | |
|---|---|---|---|---|---|---|---|---|
| Natural shrinkage (%) | 0.4 | 0.6 | 0.7 | 0.9 | 0.6 | 0.1 | 0.2 | 1.0 |
| Peel strength (gf/mm) | 10 | 17 | 28 | 30 | 31 | 24 | 20 | 31 |
| Degree of seeping | ◯ | ◯ | ◯ | ◯ | ◯ | ◯ | ◯ | ◯ |

TABLE 7

| Property evaluation | | | | | | | | |
|---|---|---|---|---|---|---|---|---|
| of heat-shrinkable | | | | | | | | |
| polyester film | | CE1 | CE2 | CE3 | CE4 | CE5 | CE6 | CE7 |
| Intrinsic viscosity (dL/g) | | 0.60 | 0.60 | 0.66 | 0.61 | 0.64 | 0.63 | 0.62 |
| Glass transition | | 71 | 68 | 66 | 71 | 65 | 66 | 65 |
| temperature (° C.) | | | | | | | | |
| Heat shrinkage in | | 69.6 | 74.4 | 75.1 | 75.6 | 75.1 | 75.5 | 76.0 |
| TD at 95° C. (%) | | | | | | | | |
| Heat shrinkage in | | 1.0 | −2.4 | 0.6 | −2.7 | 0.5 | 0.1 | 0.2 |
| MD at 95° C. (%) | | | | | | | | |
| Yield strength | | 9.0 | 6.9 | 8.4 | 6.9 | 6.4 | 6.8 | 6.7 |
| in TD (MPa) | | | | | | | | |
| Elongation at | E₀ (%) | 318 | 475 | 497 | 467 | 191 | 485 | 456 |
| break | E₁ (%) | 187 | 34 | 114 | 290 | 11 | 210 | 150 |
| Variation of | E₀-E₁ | 131 | 441 | 383 | 177 | 180 | 275 | 306 |
| elongation at | (%) | | | | | | | |
| break | | | | | | | | |

| | | | | | | | |
|---|---|---|---|---|---|---|---|
| Natural shrinkage (%) | 0.6 | 1.4 | 2.9 | 0.6 | 3.8 | 3.0 | 3.3 |
| Peel strength (gf/mm) | 12 | 35 | 33 | 36 | 52 | 43 | 45 |
| Degree of seeping | ◯ | X | ◯ | X | X | X | X |

TABLE 8

| Property evaluation | | | | | | | | | |
|---|---|---|---|---|---|---|---|---|---|
| of heat-shrinkable | | | | | | | | | |
| polyester film | | CE8 | CE9 | CE10 | CE11 | CE12 | CE13 | CE14 | CE15 |
| Intrinsic viscosity (dL/g) | | 0.63 | 0.60 | 0.63 | 0.62 | 0.61 | 0.62 | 0.63 | 0.60 |
| Glass transition | | 63 | 61 | 75 | 74 | 69 | 70 | 72 | 69 |
| temperature (° C.) | | | | | | | | | |
| Heat shrinkage in | | 76.3 | 76.3 | 71.0 | 76.3 | 75.0 | 74.0 | 68.0 | 75.0 |
| TD at 95° C. (%) | | | | | | | | | |
| Heat shrinkage in | | −0.7 | −0.5 | −1.0 | −0.3 | 0.5 | 0.3 | −0.5 | 0.2 |
| MD at 95° C. (%) | | | | | | | | | |
| Yield strength | | 6.9 | 6.2 | 13.4 | 6.4 | 6.8 | 7.1 | 13.8 | 6.2 |
| in TD (MPa) | | | | | | | | | |
| Elongation at | E₀ (%) | 50 | 148 | 474 | 498 | 425 | 489 | 424 | 420 |
| break | E₁ (%) | 3 | 3 | 434 | 472 | 120 | 101 | 83 | 56 |
| Variation of | E₀-E₁ | 47 | 145 | 40 | 26 | 305 | 388 | 341 | 364 |
| elongation at | (%) | | | | | | | | |
| break | | | | | | | | | |

| | | | | | | | | |
|---|---|---|---|---|---|---|---|---|
| Natural shrinkage (%) | 3.7 | 4.0 | 0.1 | 0.1 | 0.9 | 0.7 | 0.4 | 1.0 |
| Peel strength (gf/mm) | 41 | 46 | 4 | 33 | 34 | 28 | 2 | 35 |
| Degree of seeping | X | X | ◯ | X | X | ◯ | ◯ | X |

The results in Tables 1, 2 and 6 show that, by controlling the amount of the diol mixture to range from 18 mol % to 26 mol % and the amount of the 2-methyl-1,3-propanediol to range from 3.5 mol % to 22 mol %, the heat-shrinkable polyester films of EX1 to EX8 have a peel strength ranging from 10 gf/mm to 31 gf/mm, a yield strength in the TD ranging from 7.6 MPa to 12.4 MPa, a natural shrinkage ranging from 0.1% to 1.0%, a degree of seeping of not greater than 5% (indicated by the symbol “O”), and a variation of elongation at break ranging from 6% to 91%, indicating that in the process of introducing the heat-shrinkable polyester film of the present disclosure into the seaming machine for forming the flat-elongated hollow polyester film, the two end portions of the flat-elongated hollow polyester film which are bonded together, would not be easily affected by external forces during subsequent processes to be separated from each other, such that the heat-shrinkable polyester film can be shrunk and firmly wrapped on a container, and has an advantage of bonding stability. In addition, in the process of forming the flat-elongated hollow polyester film from the heat-shrinkable polyester film of the present disclosure, the seaming agent would not easily seep into the inner surface or the outer surface of the flat-elongated hollow film, resulting in the problem of the inner surface or the outer surface of the flat-elongated hollow film being adhered thereto would not easily occur, thereby being conducive to the production of the sleeves. Moreover, when the heat-shrinkable polyester film of the present disclosure cannot be immediately sold or used after production and requires storage, the difference between elongation of the heat-shrinkable polyester film before and after storage for a period of time is small, and thus for a heat-shrinkable film that has been stored for a period of time, in the process of forming a flat-elongated hollow film or in the process of heat-shrinking the sleeve to wrap the container, such heat-shrinkable polyester film is capable of withstanding external tensile stress without breakage under a high production speed. Since the problem of breakage of the heat-shrinkable polyester film does not occur, neither production will be suspended nor the speed of production will be decreased, such that the rate of production capacity can be maintained, thereby having an advantage of stable production processes. At the same time, the heat-shrinkable polyester film of the present disclosure naturally shrunk in a small degree after being stored for a period of time, and had a good dimensional stability after storage, and thus, even if the heat-shrinkable polyester film is not used immediately after production, the heat-shrinkable polyester film can still maintain a certain dimension, thereby meeting industrial requirements.

The discussions with regard to the heat-shrinkable polyester films of CE1 to CE15 are given hereinafter.

Referring to Tables 3 and 7, the heat-shrinkable polyester film of CE1 did not contain neopentyl glycol or 1,4-cyclohexanedimethanol, resulting in the heat-shrinkable polyester film of CE1 having a variation of elongation at break of 131%. Thus, the heat-shrinkable polyester film of CE1, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE1 easily breaks.

Referring to Tables 3 and 7, the heat-shrinkable polyester film of CE2 was prepared using diol mixture in a total amount of 29 mol % and 2-methyl-1,3-propanediol in an amount of 25 mol %, resulting in the heat-shrinkable polyester film of CE2 having a variation of elongation at break of 441%, a yield strength in the TD of 6.9 MPa, a natural shrinkage of 1.4%, and a degree of seeping of greater than 5% (indicated by the symbol “X”). Thus, the heat-shrinkable polyester film of CE2, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE2 easily breaks. In addition, in the process of forming the flat-elongated hollow polyester film from the heat-shrinkable polyester film of CE2, the seaming agent would easily seep into the inner surface or the outer surface of the flat-elongated hollow film, resulting in the problem of the inner surface or the outer surface of the flat-elongated hollow film being adhered thereto easily occurs. At the same time, the heat-shrinkable polyester film of CE2 naturally shrunk in a large degree after being stored for a period of time, and had a problem of poor dimensional stability after storage.

Referring to Tables 3 and 7, the heat-shrinkable polyester film of CE3 did not contain neopentyl glycol or 1,4-cyclohexanedimethanol, resulting in the heat-shrinkable polyester film of CE3 having a variation of elongation at break of 383% and a natural shrinkage of 2.9%. Thus, the heat-shrinkable polyester film of CE3, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE3 easily breaks. At the same time, the heat-shrinkable polyester film of CE3 naturally shrunk in a large degree after being stored for a period of time, and had a problem of poor dimensional stability after storage.

Referring to Tables 3, 4 and 7, the heat-shrinkable polyester films of CE4 to CE7 were prepared using diol mixtures in total amounts of 28 mol %, 38 mol %, 33.1 mol % and 33.8 mol %, respectively, resulting in the heat-shrinkable polyester films of CE4 to CE7 having variations of elongation at break of 177%, 180%, 275% and 306%, respectively, yield strengths in the TD of 6.9 MPa, 6.4 MPa, 6.8 MPa, and 6.7 MPa, respectively, and a degree of seeping of greater than 5% (indicated by the symbol “X”). Thus, each of the heat-shrinkable polyester films of CE4 to CE7, after being stored for a period of time, when used for making sleeve or in the process of heat-shrinking the sleeve to wrap the container after formation of the sleeve, would not be able to withstand external tensile stress under a high production speed, resulting in a problem of each of the heat-shrinkable polyester films of CE4 to CE7 easily breaks. In addition, in the process of forming the flat-elongated hollow polyester film from each of the heat-shrinkable polyester films of CE4 to CE7, the seaming agent would easily seep into the inner surface or the outer surface of the flat-elongated hollow film, resulting in the problem of the inner surface or the outer surface of the flat-elongated hollow film being adhered thereto easily occurs. Referring again to Table 7, the heat-shrinkable polyester films of CE5 to CE7 respectively have natural shrinkage of 3.8%, 3.0% and 3.3%, and apart from the aforesaid problems, the heat-shrinkable polyester films of CE5 to CE7 naturally shrunk in a large degree after being stored for a period of time, and had a problem of poor dimensional stability after storage. It should be noted that the heat-shrinkable polyester film of CE5 was prepared using a raw material similar to that used for forming the polyester disclosed in WO 2022/072477 A1, and thus, the heat-shrinkable film disclosed in this patent document has problems of breakage, adhesion, and poor dimensional stability after storage, thereby unable to meet the requirements of the present disclosure.

Referring to Tables 4 and 8, the heat-shrinkable polyester film of CE8 was prepared using diol mixture in a total amount of 32 mol %, and 2-methyl-1,3-propanediol in an amount of 24 mol %, and did not contain neopentyl glycol or 1,4-cyclohexanedimethanol, resulting in the heat-shrinkable polyester film of CE8 having a yield strength in the TD of 6.9 MPa, a natural shrinkage of 3.7%, and a degree of seeping of greater than 5% (indicated by the symbol “X”). It should be noted that the heat-shrinkable polyester film of CE8 was prepared using a raw material similar to that used for forming the polyester of EX1 disclosed in WO 2022/076765 A1. Therefore, in the process of forming the flat-elongated hollow polyester film from the heat-shrinkable polyester film of CE8, the seaming agent would easily seep into the inner surface or the outer surface of the flat-elongated hollow film, resulting in the problem of the inner surface or the outer surface of the flat-elongated hollow film being adhered thereto easily occurs. In addition, the heat-shrinkable polyester film of CE8 naturally shrunk in a large degree after being stored for a period of time, and had a problem of poor dimensional stability after storage.

Referring to Tables 4 and 8, the heat-shrinkable polyester film of CE9 was prepared using diol mixture in a total amount of 34 mol %, and 2-methyl-1,3-propanediol in an amount of 24 mol %, and did not contain neopentyl glycol or 1,4-cyclohexanedimethanol, resulting in the heat-shrinkable polyester film of CE9 having a yield strength in the TD of 6.2 MPa, a natural shrinkage of 4.0%, and a degree of seeping of greater than 5% (indicated by the symbol “X”). It should be noted that the heat-shrinkable polyester film of CE9 was prepared using a raw material same to that used for forming the polyester of EX8 disclosed in WO 2022/076765 A1. Therefore, the heat-shrinkable polyester film of CE9, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE9 easily breaks. In addition, in the process of forming the flat-elongated hollow polyester film from the heat-shrinkable polyester film of CE9, the seaming agent would easily seep into the inner surface or the outer surface of the flat-elongated hollow film, resulting in the problem of the inner surface or the outer surface of the flat-elongated hollow film being adhered thereto easily occurs. Moreover, the heat-shrinkable polyester film of CE9 naturally shrunk in a large degree after being stored for a period of time, and had a problem of poor dimensional stability after storage.

Referring to Tables 4 and 8, the heat-shrinkable polyester film of CE10 was prepared using diol mixture in a total amount of 17.5 mol %, resulting in the heat-shrinkable polyester film of CE10 having a yield strength in the TD of 13.4 MPa and a peel strength of 4 gf/mm. Thus, in the process of forming the flat-elongated hollow polyester film from the heat-shrinkable polyester film of CE10, and even after heat-shrinking the flat-elongated hollow polyester film to wrap the container, the two end portions of the heat-shrinkable polyester film which are bonded together, would be easily affected by external forces during subsequent processes and become separated from each other. Therefore, the heat-shrinkable polyester film of CE10 has a poor bonding stability.

Referring to Tables 5 and 8, the heat-shrinkable polyester film of CE11 was prepared using diol mixture in a total amount of 26.5 mol %, resulting in the heat-shrinkable polyester film of CE11 having a yield strength in the TD of 6.4 MPa and a degree of seeping of greater than 5% (indicated by the symbol “X”). Thus, in the process of forming the flat-elongated hollow polyester film from the heat-shrinkable polyester film of CE11, the seaming agent would easily seep into the inner surface or the outer surface of the flat-elongated hollow film, resulting in the problem of the inner surface or the outer surface of the flat-elongated hollow film being adhered thereto easily occurs.

Referring to Tables 5 and 8, the heat-shrinkable polyester film of CE12 was prepared using diol mixture in a total amount of 26.5 mol %, and 2-methyl-1,3-propanediol in an amount of 22.5 mol %, resulting in the heat-shrinkable polyester film of CE12 having a variation of elongation at break of 305%, yield strength in the TD of 6.8 MPa, and a degree of seeping of greater than 5% (indicated by the symbol “X”). Thus, the heat-shrinkable polyester film of CE12, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE12 easily breaks. In addition, in the process of forming the flat-elongated hollow polyester film from the heat-shrinkable polyester film of CE12, the seaming agent would easily seep into the inner surface or the outer surface of the flat-elongated hollow film, resulting in the problem of the inner surface or the outer surface of the flat-elongated hollow film being adhered thereto easily occurs.

Referring to Tables 5 and 8, the heat-shrinkable polyester film of CE13 was prepared using 2-methyl-1,3-propanediol in an amount of 22.5 mol %, resulting in the heat-shrinkable polyester film of CE13 having a variation of elongation at break of 388% and a yield strength in the TD of 7.1 MPa. Thus, the heat-shrinkable polyester film of CE13, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE13 easily breaks.

Referring to Tables 5 and 8, the heat-shrinkable polyester film of CE14 was prepared using diol mixture in a total amount of 17.5 mol %, resulting in the heat-shrinkable polyester film of CE14 having a yield strength in the TD of 13.8 MPa, a peel strength of 2 gf/mm, and a variation of elongation at break of 341%. Thus, in the process of forming the flat-elongated hollow polyester film from the heat-shrinkable polyester film of CE14, and even after heat-shrinking the flat-elongated hollow polyester film to wrap the container, the two end portions of the heat-shrinkable polyester film which are bonded together, would be easily affected by external forces during subsequent processes and become separated from each other. Therefore, the heat-shrinkable polyester film of CE14 has a poor bonding stability. In addition, the heat-shrinkable polyester film of CE14, after being stored for a period of time, when used for making sleeve or in the process of heat-shrinking the sleeve to wrap the container after formation of the sleeve, would not be able to withstand external tensile stress under a high production speed, resulting in a problem of the heat-shrinkable polyester film of CE14 easily breaks.

Referring to Tables 5 and 8, the heat-shrinkable polyester film of CE15 was prepared using diol mixture in a total amount of 26.5 mol %, resulting in the heat-shrinkable polyester film of CE15 having a variation of elongation at break of 364%, yield strength in the TD of 6.2 MPa, and a degree of seeping of greater than 5% (indicated by the symbol “X”). Thus, the heat-shrinkable polyester film of CE15, when used for making sleeve or in the process of heat-shrinking the sleeve to wrap the container after formation of the sleeve, would not be able to withstand external tensile stress under a high production speed, resulting in a problem of the heat-shrinkable polyester film of CE15 easily breaks. In addition, in the process of forming the flat-elongated hollow polyester film from the heat-shrinkable polyester film of CE15, the seaming agent would easily seep into the inner surface or the outer surface of the flat-elongated hollow film, resulting in the problem of the inner surface or the outer surface of the flat-elongated hollow film being adhered thereto easily occurs.

In summary, in the process of introducing the heat-shrinkable polyester film of the present disclosure into the seaming machine for forming the flat-elongated hollow polyester film, the two end portions of the flat-elongated hollow polyester film which are bonded together would not be easily affected by external forces during subsequent processes to be separated from each other, and the seaming agent would not seep into the inner surface or the outer surface of the flat-elongated hollow film, so that the problem of the inner surface or the outer surface of the flat-elongated hollow film being adhered thereto would not easily occur, thereby being conducive to the production of the sleeves. In addition, the difference between elongation of the heat-shrinkable polyester film before and after storage for a period of time is small, and thus for a heat-shrinkable film that has been stored for a period of time, when used for making sleeve or in the process of heat-shrinking the sleeve to wrap the container after formation of the sleeve, the heat-shrinkable polyester film would not easily break due to external tensile stress under a high production speed, thereby maintaining the rate of production capacity. At the same time, the heat-shrinkable polyester film of the present disclosure naturally shrunk in a small degree after being stored for a period of time, and had a good dimensional stability after storage, and thus, even if the heat-shrinkable polyester film is not used immediately after production, the heat-shrinkable polyester film can still maintain a certain dimension.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A heat-shrinkable polyester film, comprising a polyester resin made from a dicarboxylic component and a diol component,
wherein the dicarboxylic component includes at least one of terephthalic acid and dimethyl terephthalate, the diol component including ethylene glycol and a diol mixture that includes a first diol and a second diol, the first diol being 2-methyl-1,3-propanediol, the second diol being selected from the group consisting of neopentyl glycol, 1,4-cyclohexanedimethanol, and a combination thereof,
wherein based on 100 mol % of the diol component, the ethylene glycol is present is an amount ranging from 74 mol % to 82 mol %, the diol mixture is present in an amount ranging from 18 mol % to 26 mol %, and the 2-methyl-1,3-propanediol is present in an amount ranging from 3.5 mol % to 22 mol %, and
wherein the heat-shrinkable polyester film has:
a heat shrinkage in a direction transverse to a machine direction of greater than 48% in hot water at 95° C. for 10 seconds;
a heat shrinkage in the machine direction of less than 5% in hot water at 95° C. for 10 seconds;
an intrinsic viscosity of greater than 0.5 dL/g; and
a yield strength in the direction transverse to the machine direction which ranges from 7.5 MPa to 13 MPa.

2. The heat-shrinkable polyester film as claimed in claim 1, wherein the heat-shrinkable polyester film has a natural shrinkage that is not greater than 1% and that is calculated using the following Equation (I):
$$Natural shrinkage = [ ( {A}_{0} - {A}_{1} ) \div {A}_{0} ] \times 100 \% , \qquad ( I )$$
wherein,
A₀ represents a first length of the heat-shrinkable polyester film in a direction before a treatment, and
A₁ represents a second length of the heat-shrinkable polyester film in the direction after the treatment, the heat-shrinkable polyester film in the treatment being treated at a temperature of 40° C. and a relative humidity of 65% for 168 hours.

3. The heat-shrinkable polyester film as claimed in claim 1, wherein the heat-shrinkable polyester film has a variation of elongation at break that is not greater than 100% and that is an absolute value of difference in elongation at break of the heat-shrinkable polyester film before an aging treatment and elongation at break of the heat-shrinkable polyester film after the aging treatment, the heat-shrinkable polyester film in the aging treatment being treated at a temperature of 60° C. for 1 hour.

4. The heat-shrinkable polyester film as claimed in claim 1, wherein the second diol is present in an amount ranging from 4 mol % to 22 mol % based on 100 mol % of the diol component.

5. The heat-shrinkable polyester film as claimed in claim 1, wherein the second diol is present in an amount ranging from 4 mol % to 17 mol % based on 100 mol % of the diol component.

6. The heat-shrinkable polyester film as claimed in claim 1, wherein the 2-methyl-1,3-propanediol is present in an amount ranging from 3.5 mol % to 20 mol % based on 100 mol % of the diol component.

7. The heat-shrinkable polyester film as claimed in claim 1, wherein based on 100 mol % of the diol component, the diol mixture is present in an amount ranging from 21 mol % to 25 mol % and the 2-methyl-1,3-propanediol is present in an amount ranging from 17 mol % to 20 mol %.

8. The heat-shrinkable polyester film as claimed in claim 1, wherein the diol component further includes bis(2-hydroxyethyl) terephthalate.

9. The heat-shrinkable polyester film as claimed in claim 1, wherein the diol component is free from polyethylene glycol.

10. The heat-shrinkable polyester film as claimed in claim 9, wherein the polyethylene glycol is selected from diethylene glycol, triethylene glycol, and a combination thereof.

11. The heat-shrinkable polyester film as claimed in claim 1, wherein the heat shrinkage of the heat-shrinkable polyester film in the direction transverse to the machine direction is not less than 55% in hot water at 95° C. for 10 seconds.

12. The heat-shrinkable polyester film as claimed in claim 1, wherein the heat shrinkage of the heat-shrinkable polyester film in the direction transverse to the machine direction is not less than 65% in hot water at 95° C. for 10 seconds.

13. The heat-shrinkable polyester film as claimed in claim 1, wherein the heat shrinkage of the heat-shrinkable polyester film in the direction transverse to the machine direction is not less than 72% in hot water at 95° C. for 10 seconds.

14. The heat-shrinkable polyester film as claimed in claim 1, wherein the heat shrinkage of the heat-shrinkable polyester film in the machine direction is not greater than 4% in hot water at 95° C. for 10 seconds.

15. The heat-shrinkable polyester film as claimed in claim 1, wherein the heat shrinkage of the heat-shrinkable polyester film in the machine direction is not greater than 3% in hot water at 95° C. for 10 seconds.

16. The heat-shrinkable polyester film as claimed in claim 1, wherein the heat-shrinkable polyester film has a thickness ranging from 35 μm to 50 μm.

17. The heat-shrinkable polyester film as claimed in claim 2, wherein the natural shrinkage of the heat-shrinkable polyester film ranges from 0.1% to 1.0%.

18. The heat-shrinkable polyester film as claimed in claim 1, wherein the heat-shrinkable polyester film has a peel strength ranging from 10 gf/mm to 31 gf/mm.
